(19) United States
(12) Patent Application Publication
(10) Pub. No.: US 2014/0290476 A1
(43) Pub. Date: Oct. 2, 2014

(54) BRAKE SYSTEM PUMP ELEMENT WITH AXIAL FLOW PISTON

(71) Applicant: Robert Bosch GmbH, Stuttgart (DE)

(72) Inventors: Guy E. Michalski, Charleston, SC (US); Douglas Patterson, Summerville, SC (US)

(21) Appl. No.: 13/924,174

(22) Filed: Jun. 21, 2013

Related U.S. Application Data
(60) Provisional application No. 61/806,627, filed on Mar. 29, 2013.

(51) Int. Cl. F16J 1/00

(52) U.S. Cl. CPC F16J 1/00
USPC 92/172

(57) ABSTRACT

A pump element includes a body defining a chamber. A piston assembly is biased to a first position within the chamber and is configured to be driven along an axis from the first position to a second position to compress fluid. At least one flow path is defined through the piston assembly from an upstream end to a downstream end, and the at least one flow path is configured to receive flow only in the axial direction.

### CROSS-REFERENCE TO RELATED APPLICATIONS

This application claims priority to U.S. Provisional Patent Application No. 61/806,627, filed Mar. 29, 2013, the entire contents of which are incorporated by reference herein.

### BACKGROUND

The present invention relates to pistons in hydraulic pumps. In particular, the invention relates to an axial flow piston. The axial flow piston can be utilized in a hydraulic unit of a vehicle braking system.

### SUMMARY

In one aspect, the invention provides a pump element including a body defining a chamber. A piston rod is configured to be driven along an axis from a first position to a second position to compress fluid. The piston rod has a solid outer surface without any apertures or passages formed therein. An axial flow element is configured to be driven along with the piston rod from the first position to the second position. The axial flow element includes a radially outer surface portion defining a seal with the chamber. A biasing member biases the piston rod and the axial flow element toward the first position. The axial flow element has a continuous, solid peripheral wall, at least one inlet at a first axial end, at least one outlet at a second axial end, and a flow path extending from the at least one inlet to the at least one outlet.

In another aspect, the invention provides a pump element including a body defining a chamber. A piston assembly is biased to a first position within the chamber and is configured to be driven along an axis from the first position to a second position to compress fluid. At least one flow path is defined through the piston assembly from an upstream end to a downstream end, and the at least one flow path is configured to receive flow only in the axial direction.

Other independent aspects of the invention will become apparent by consideration of the detailed description and accompanying drawings.

### BRIEF DESCRIPTION OF THE DRAWINGS

FIG. 1 is a schematic view of a braking system of a vehicle.

FIG. 2 is a cross-sectional view of a first known pump element configuration.

FIG. 3 is a cross-sectional view of a second known pump element configuration.

FIG. 4 is a cross-sectional view of a pump element having an axial flow element according to one aspect of the invention.

FIG. 4A is a perspective view of the axial flow element of the pump element of FIG. 4.

FIG. 5 is an end view of an axial flow piston assembly according to another aspect of the invention.

FIG. 5A is a cross-sectional view taken along line A-A of the piston assembly of FIG. 5.

FIG. 5B is a cross-sectional view taken along line B-B of the piston assembly of FIG. 5.

FIG. 6 is a perspective cross-sectional view of an axial flow element of the piston assembly of FIG. 5.

FIG. 7 is a cross-sectional view illustrating the inlet valve element in a closed position on the axial flow element.

FIG. 8 is a cross-sectional view illustrating the inlet valve element in an open position on the axial flow element.

FIG. 9 is a molding tool layout for the axial flow element of FIGS. 5-8.

FIG. 10 is a molding tool layout for the axial flow element of FIG. 4.

FIG. 11 is an end view of a piston assembly with an axial flow element according to yet another construction.

FIG. 11A is a cross-sectional view, taken along line A-A of the piston assembly of FIG. 11.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

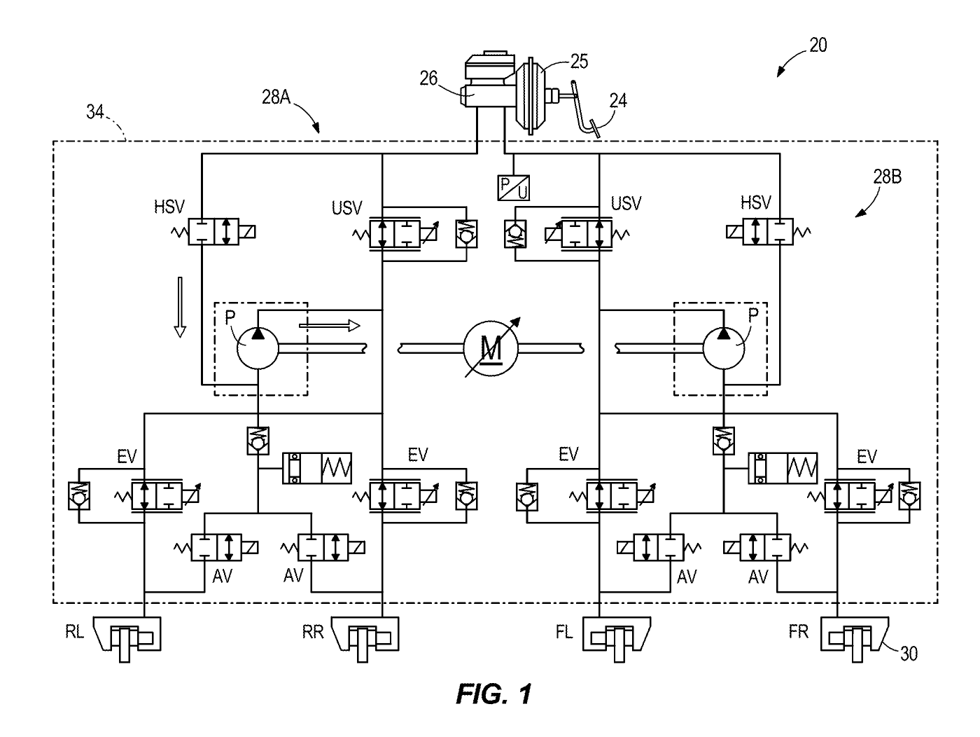

FIG. 1 illustrates a hydraulic braking system 20 including a pedal 24, a booster 25, a master cylinder 26, and two parallel braking circuits 28A, 28B, each having two wheel cylinders 30. In addition to an array of valves (e.g., a high pressure switching valve HSV and a pilot valve USV for each circuit and inlet and outlet valves EV, AV for each wheel cylinder 30) that control the connection of hydraulic lines or passages, a pump P is provided in each circuit 28A, 28B. The pumps P of the two circuits 28A, 28B can be jointly driven by a common motor M. Each pump P is operable, when driven, to generate a hydraulic pressure and flow of fluid within the associated circuit 28A, 28B. Although schematically illustrated as a single pump P for each circuit 28A, 28B, the pump P may be provided as a plurality of individual pumping elements. All the pump elements may be provided, along with the valves and connection ports, within a common housing 34 or unit, referred to as the hydraulic unit or “HU”. The illustrated braking system 20 is configured for anti-lock braking (ABS) and electronic stability control (ESC). Although the illustrated braking system 20 illustrates one example of a braking system according to aspects of the invention, the invention may also be applied to any one of a variety of other types of braking systems as will be appreciated by those of skill in the art.

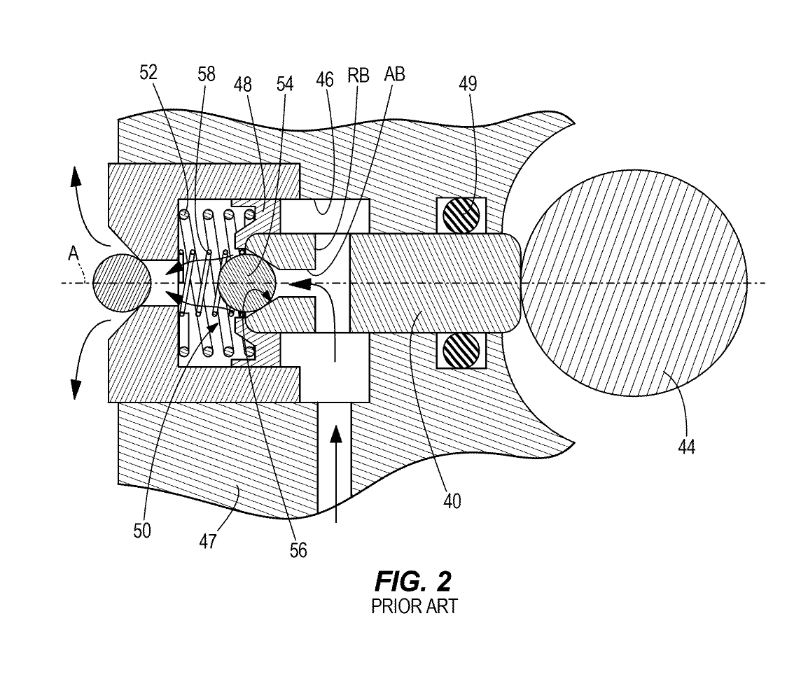

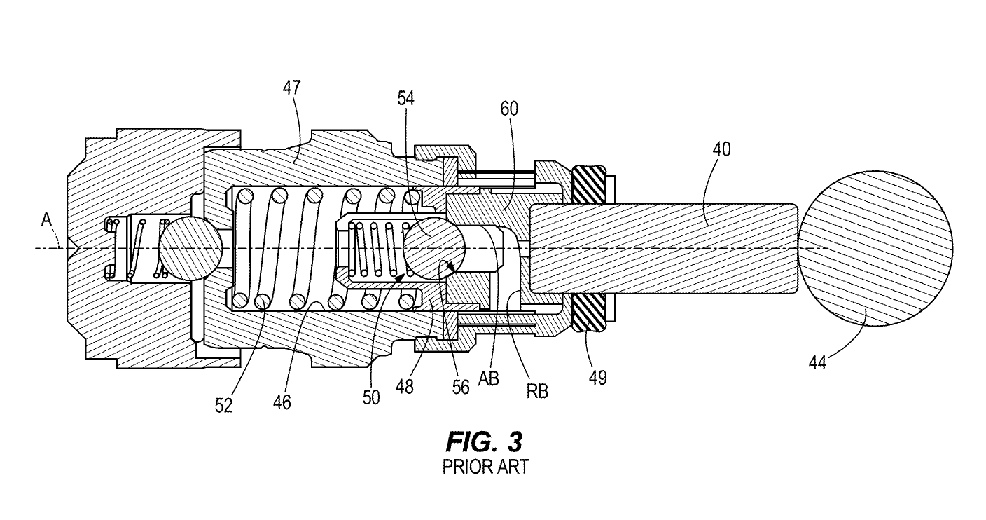

Each pump P can include piston pump elements. Typical geometries for a piston pump element used in ABS/ESC systems are shown in the sectional views of FIGS. 2 and 3. Existing pump element designs consist of a piston rod 40 (e.g., made from a bearing needle) that is driven by a driver 44 (e.g., eccentric motor output member) to reciprocate along an axis A within a chamber 46 defined by a body 47. As shown in FIG. 2, the chamber 46 is divided into a low pressure area and a high pressure area by a high pressure seal 48 and an inlet valve 50. The inlet valve 50 includes valve element 54 (e.g., a ball or disk) biased into contact with a valve seat 56 formed at the end of the piston rod 40 by a spring 58, although functional designs without inlet valve return springs can exist if the valve element is enclosed in a manner where it operates satisfactorily with hydraulic forces alone. A piston return spring 52 keeps the entire piston assembly (including the piston rod 40, the high pressure seal 48, and the inlet valve 50) biased to the non-actuated position (i.e., toward the driver 44). An outlet valve 59 is positioned at an outlet end of the high pressure area of the chamber 46. The pump design, which features a larger sealing diameter on the high pressure side than on the low pressure side (i.e., where the outside of the piston rod 40 contacts a stationary sealing member 49), is known as a “stepped” piston design. The stepped piston design generally provides a more continuous suction behavior and helps reduce hydraulic hammering effect and cavitation in the suction line, since the pump is allowed to draw fluid during its compression stroke as well as during the return stroke of the piston assembly.

In the type of known construction shown in FIG. 2, the piston rod 40 is machined to include intersecting radial and axial bores RB, AB. The axial bore AB is in fluid communication with the inlet valve 50 at the working end of the piston assembly, and the radial bore(s) RB is in communication with a low pressure fluid source to supply fluid fore pressurization in the chamber 46, by passing through the inlet valve 50 when the piston is stroked. The flow path requires the fluid entering the pump to turn 90 degrees which increases the hydraulic resistance of the fluid as it passes through the piston assembly.

In the type of known construction shown in FIG. 3, the radial and axial fluid bores RB, AB are incorporated into a separate piston sealing element 60 or “valve seat” element adjacent the piston rod 40 and movable therewith. Thus, the piston rod 40 need not be machined with the bores RB, AB, but the flow configuration through the piston assembly as a whole is generally the same as that of FIG. 2. In either design, the fluid flow path through the pump element has a sharp turn in it. The cross sectional area supporting the axial load of the piston assembly at the centerline of the radial bore(s) RB is low. This limits the materials which can be used for this portion of the piston assembly (piston rod 40 in FIG. 2, valve seat element 60 in FIG. 3). Normally, this part must be made of steel to be sufficiently robust. In addition, multiple manufacturing process steps are generally required to produce this component.

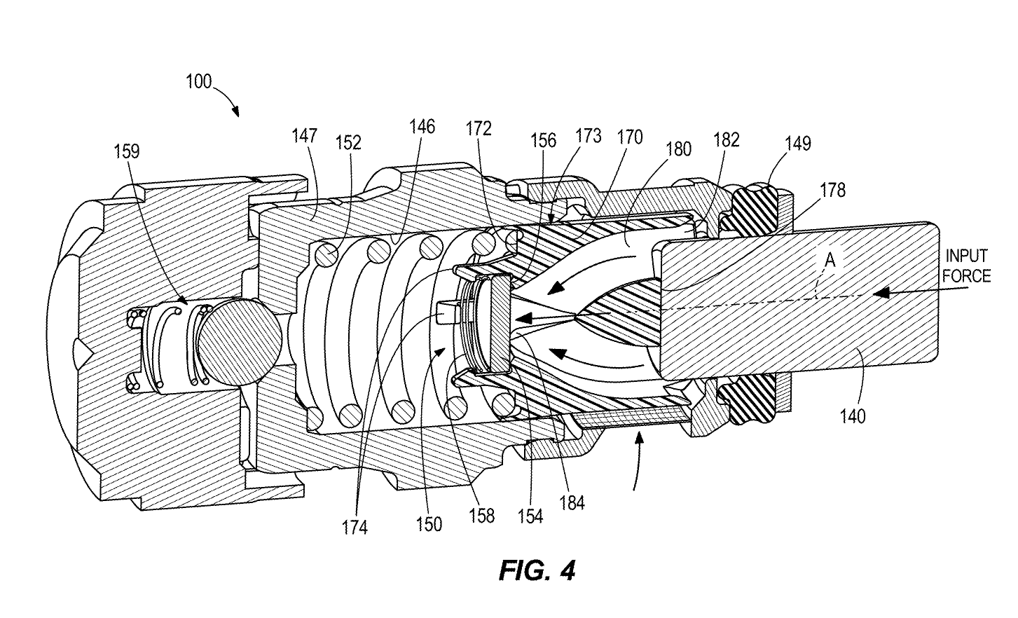

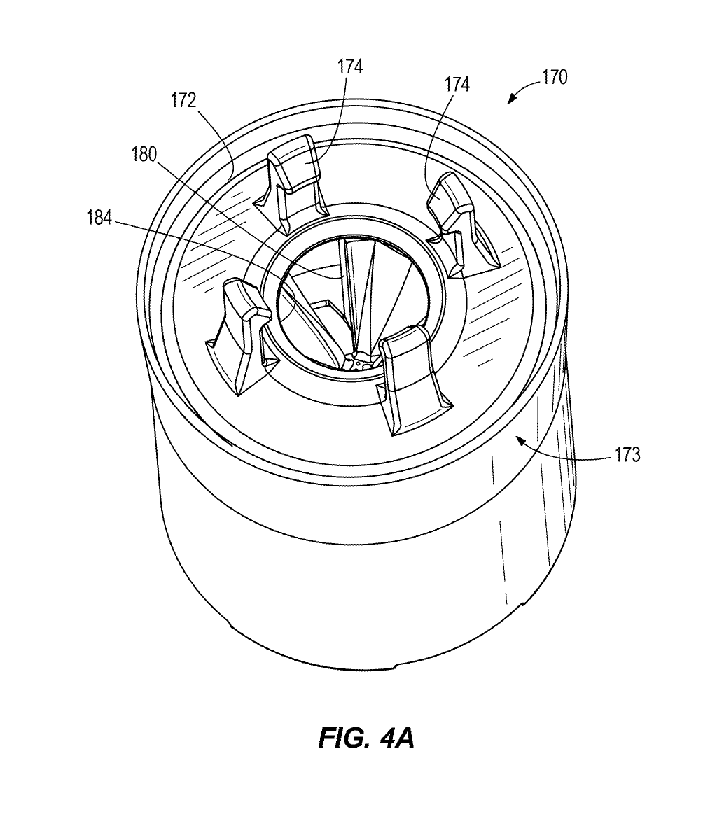

FIG. 4 illustrates a pump element 100 having a piston assembly drivable to reciprocate along the axis A, and providing continuous axial flow from an inlet end to an outlet end without intersecting radial and axial bores. Reference numbers are similar to those of FIGS. 2 and 3 where appropriate, but with a leading “1”. The piston assembly includes a piston “head” or axial flow element 170 positioned at the working end of the piston rod 140 for movement with the piston rod 140. The return spring 152 biases the entire piston assembly toward the non-actuated position in the absence of a driving input on the remote end of the piston rod 140. The return spring 152 can contact the axial flow element 170 directly at a spring seat 172 thereof. The axial flow element 170 has a radial outer surface portion 173 in contact with the wall of the chamber 146 to function as the high pressure seal, without necessitating an additional, separately-formed component. The axial flow element 170 also includes a valve seat 156 which cooperates with the inlet valve element 154 (e.g., a disk, as shown). Alternately, the inlet valve element 154 can be provided by a ball. Retainer members 174 are formed at the distal end of the axial flow element 170 to retain the inlet valve 154, and the corresponding inlet valve spring 158. The retainer members 174 can be a circumferential array of barbed fingers as shown in the illustrated construction, but may also take on other constructions. In other constructions, the inlet valve 150 is positioned upstream of the piston assembly and may not be supported by the axial flow element 170 or the piston assembly as a whole. The axial flow element 170 can be constructed of non-metallic material.

The piston rod 140 engages the axial flow element 170 at an upstream or inlet end of the axial flow element 170. In the illustrated construction, the axial flow element 170 is formed with a recess 178 that receives an end portion of the piston rod 140, but other interfacing arrangements are optional. One or more flow passages 180 are provided through the axial flow element 170 from the inlet end to the outlet end. In the illustrated construction, an array of flow passages 180 are provided, each having a separate inlet 182 at the inlet end of the axial flow element 170. Each inlet 182 is configured and arranged to receive flow in the axial direction. In other words, the inlets 182 are opened or facing in the axial direction. All of the flow passages 180 converge at a common, centrally located outlet 184 in the illustrated construction, but other arrangements are also envisioned. When the pressure differential is sufficient, the fluid flows through the inlet valve 150 into the high pressure area of the chamber 146. As shown in FIG. 4, each of the passages 180 can have a subtle arc shape toward the axis A in the downstream direction. Although this presents a radially inward flow component, the flow through the axial flow element 170 is never required to travel in a strictly radial direction, and at any given point along the passages 180, the mean flow direction is primarily axial. The number of flow passages 180 in the flow element 170 can be one, two, three, multiples thereof, or any convenient number within the physical limitations of construction. In some constructions, multiple passages 180 are provided in an evenly spaced circumferential array about the axis A.

The fluid flow through the illustrated flow element 170 is more continuous than the flow path with the conventional pump designs, offering lower overall fluid resistance and better pump efficiency. The minimum cross sectional area of material at any point perpendicular to the axis A along the flow element 170 is higher than that provided by prior designs of similar size, which have an inherent and significant reduction at the location where the radial bores RB intersect the axial flow bores AB in the conventional designs. This reduces the average axial stress in the flow element 170 during operation and increases the types of materials which can be used to manufacture the flow element for a given application (e.g., plastic, resin, etc.). This further enables the opportunity to avoid the use of a separate component for the high pressure sealing element and eliminates the need to perform specific machining operations to add flow path canal bores in the piston rod 140. The piston rod 140 used with the axial flow element 170 can be a simple rod (e.g., centerless ground) with a continuous cylindrical outer surface, free from apertures, openings, perforations, etc. Thus, cost advantage with the axial flow element 170 can be realized by component count reduction, material selection, manufacturing (machining elimination), and assembly.

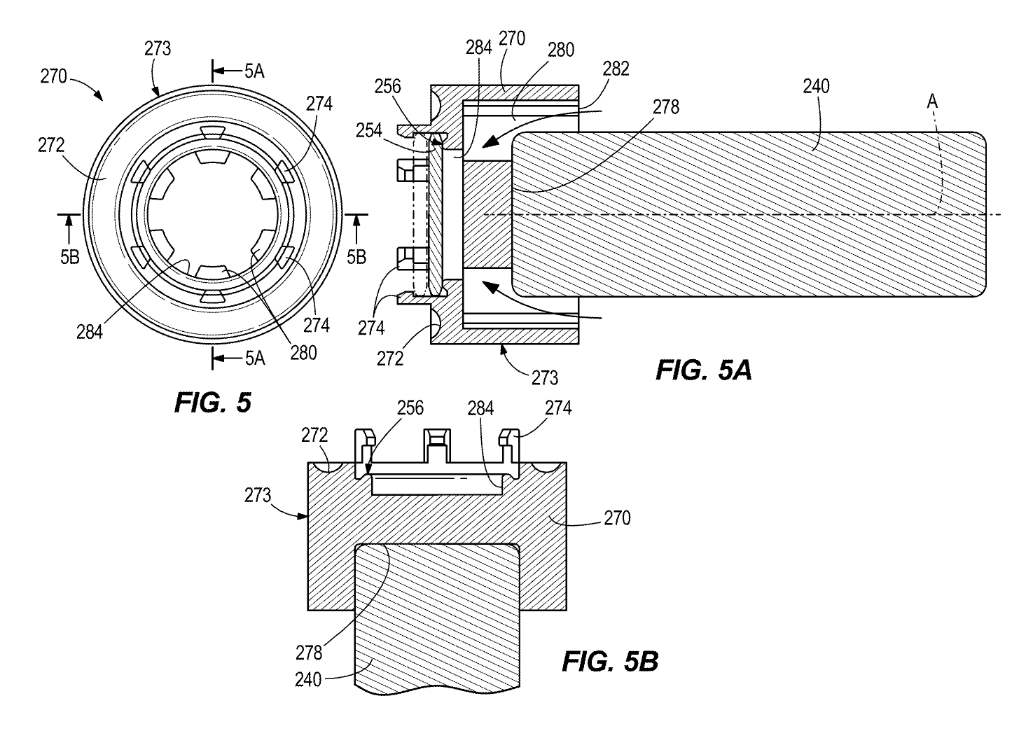

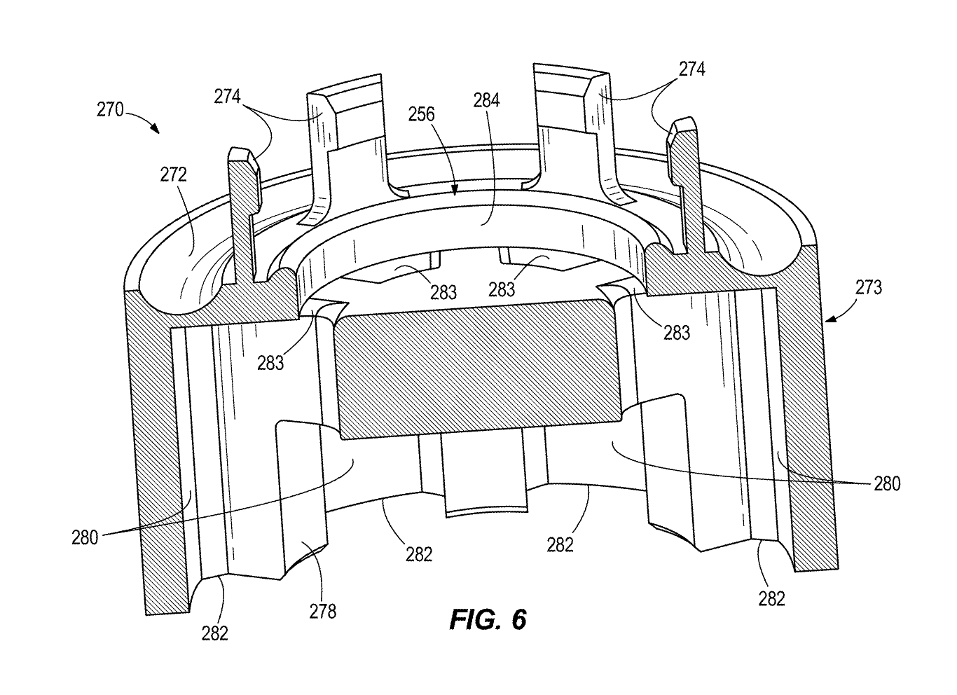

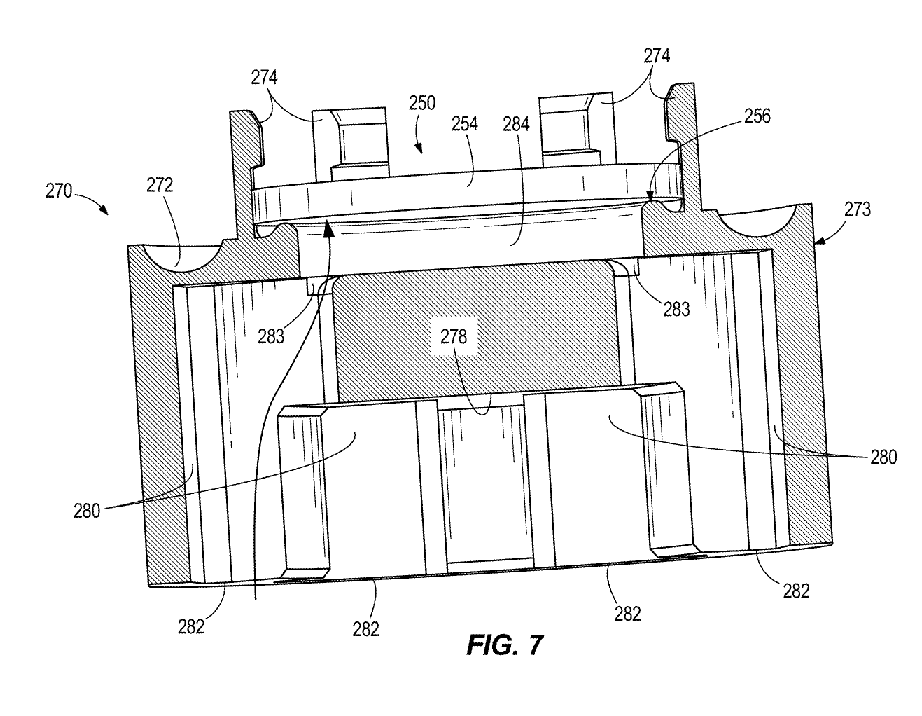

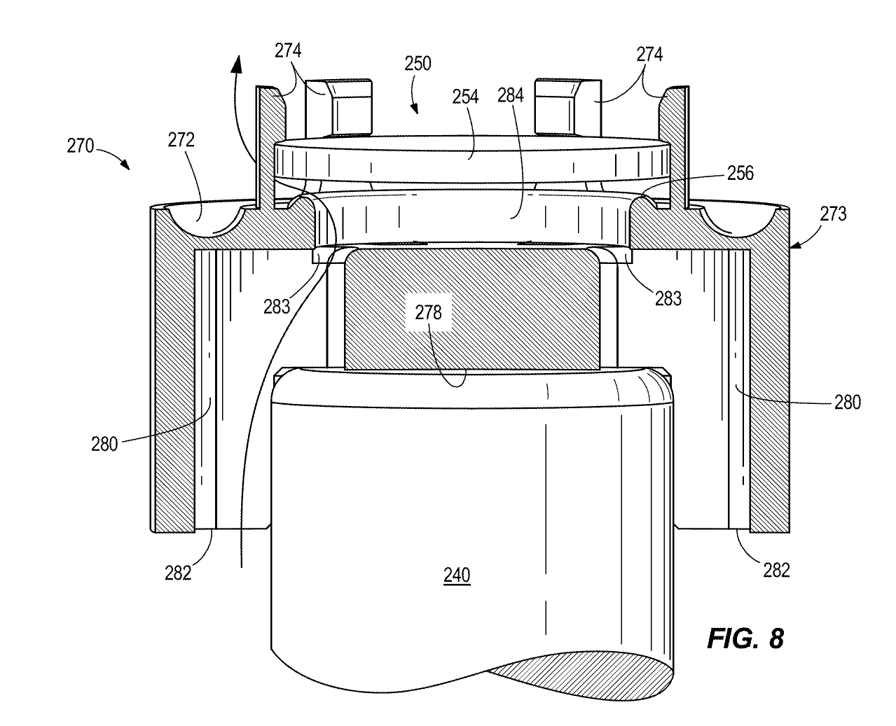

FIGS. 5-8 illustrate an axial flow element 270 that is generally similar to the axial flow element 170 of FIGS. 4 and 4A, except as noted below. Similar reference numbers are used, with a leading “2”. As shown in FIG. 5, the axial flow element 270 includes six flow passages 280 equally dispersed about the axis A. Like the axial flow element 170 of FIGS. 4 and 4A, all of the flow passages 280 converge to a common outlet 284 where the valve element 254 of the inlet valve 250 for the compression chamber is positioned. Slots 283, which have a trapezoidal cross-sectional shape, provide the transition from the individual flow passages 280 to the common outlet 284. Rather than a continuous arcuate shape like that of the flow passages 180, each flow passage 280 is made up of generally straight segments. The axial flow element 270 still provides axial admittance of fluid via the inlets 282 and axial discharge via the outlet 284. Thus, regardless of which axial flow element 170, 270 is provided, radial inflow of fluid to the piston assembly is avoided and the flow element 170, 270 has a continuous, solid peripheral wall. Six retainer members are formed at the distal end of the axial flow element 270 to retain the inlet valve element 254.

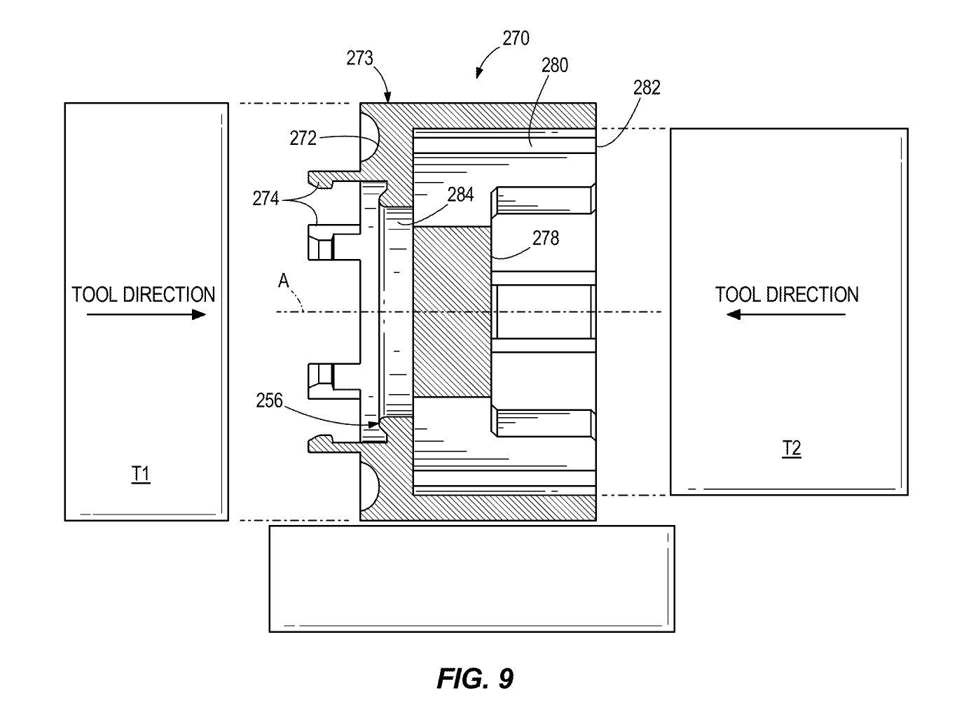

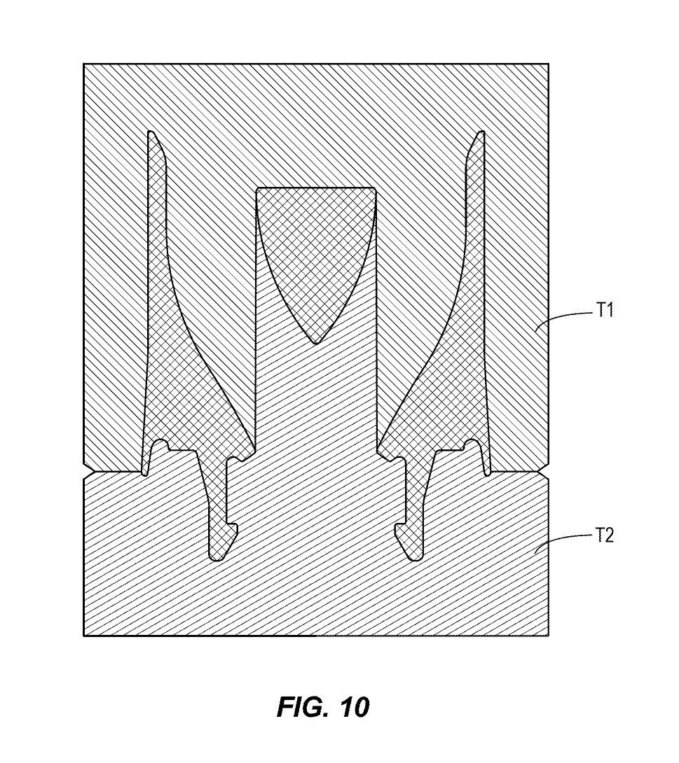

The axial flow element 270 can be molded using a first tool T1 having an array of “fingers” from the inlet end which intersect with a single pin of a second tool T2 coming from the outlet end as shown in FIG. 9. In other words, the entirety of the flow passages 280 through the axial flow element 270 can be formed by molding tools that are axially-mating and separating, and there is no portion of any flow passage that cannot be reached from one or the other of the axial ends of the flow element 270 since the flow passages 280 are formed only by axially intersecting sections. The same may be true of the other constructions disclosed herein, although not explicitly illustrated. For example, FIG. 10 shows an exemplary tooling parting line between tools T1 and T2 when cut through the flow path portion for the axial flow element 170 of FIGS. 4 and 4A.

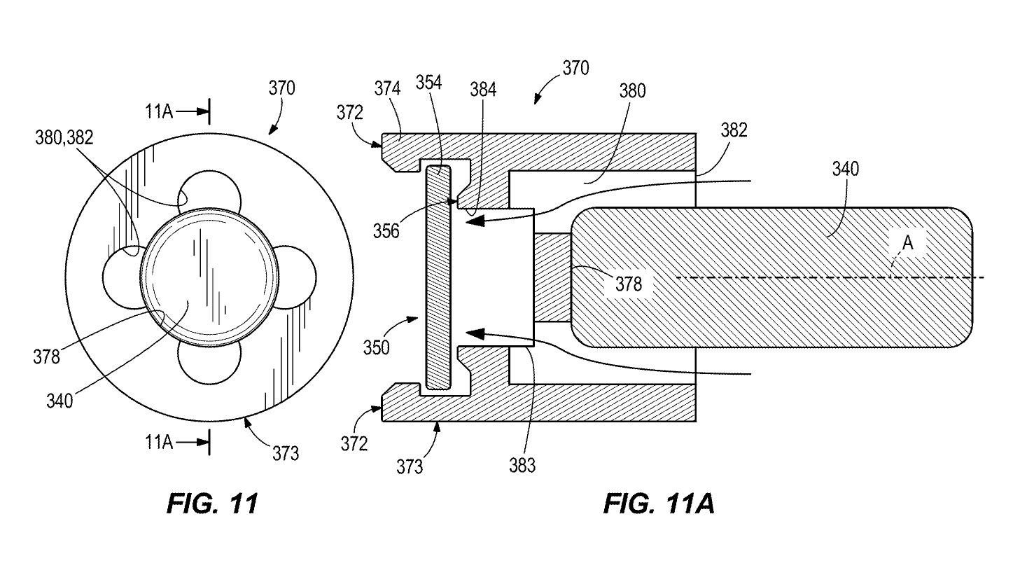

FIGS. 11 and 11A illustrate an axial flow element 370 that is generally similar to the axial flow elements 170, 270 of FIGS. 4-8, except as noted below. Similar reference numbers are used, with a leading “3”. As shown in FIG. 11, the inlets 382 and the flow passages 380 have a cross-sectional shape which is generally round or semi-circular. Compared to the axial flow elements 170, 270, the axial flow element 370 accommodates a larger diameter inlet valve element 354. In fact, the retainer members 374 are positioned at the radially outer edge of the flow element 370, and no separate spring seat is provided. In some constructions, the retainer members 374 themselves provide an axial surface 372 providing the spring seat.

The axial flow element according to any of the constructions disclosed herein offers a low cost design approach for a high pressure pump element piston head used in modulation in a positive displacement pump. The function of the machined metal valve seat and the high pressure plastic seal of previous designs (FIG. 3) are incorporated, along with inlet valve element retention, into a single component (e.g., a single molded plastic piece). As mentioned above, the “weak area” of the conventional piston is eliminated. The axial flow pump element may also offer advantages because the flow direction of the fluid is more linear, traveling predominately only in an axial direction towards the compression chamber of the pump.

Various features and advantages of the invention are set forth in the following claims.

What is claimed is:

1. A pump element comprising:
a body defining a chamber;
a piston rod configured to be driven along an axis from a first position to a second position to compress fluid, the piston rod having a solid outer surface without any apertures or passages formed therein;
an axial flow element configured to be driven along with the piston rod from the first position to the second position, the axial flow element including a radially outer surface portion defining a seal with the chamber; and
a biasing member biasing the piston rod and the axial flow element toward the first position,
wherein the axial flow element has a continuous, solid peripheral wall, at least one inlet at a first axial end, at least one outlet at a second axial end, and a flow path extending from the at least one inlet to the at least one outlet.

2. The pump element of claim 1, wherein the pump element is provided in a hydraulic unit of a vehicle braking system in fluid communication with a master cylinder and at least one wheel cylinder.

3. The pump element of claim 1, wherein the axial flow element is entirely constructed of a non-metallic material.

4. The pump element of claim 1, wherein the axial flow element includes a plurality of inlets at the first axial end.

5. The pump element of claim 4, wherein the plurality of inlets are provided in an evenly distributed pattern.

6. The pump element of claim 4, wherein the plurality of inlets are in communication with a corresponding plurality of discrete passages, all of which converge to a single outlet at the second axial end of the axial flow element.

7. The pump element of claim 1, wherein the axial flow element supports an inlet valve and includes a seat surface selectively contacting a valve element of the inlet valve.

8. The pump element of claim 7, wherein the axial flow element includes a plurality of retainers at the second axial end, the plurality of retainers configured to retain the inlet valve element with respect to the axial flow element.

9. The pump element of claim 8, wherein the inlet valve element is a disk.

10. The pump element of claim 1, wherein the piston rod defines a first sealing diameter less second than a sealing diameter between the chamber and the radially outer surface portion of the axial flow element.

11. A pump element comprising:
a body defining a chamber;
a piston assembly biased to a first position within the chamber and configured to be driven along an axis from the first position to a second position to compress fluid, at least one flow path being defined through the piston assembly from an upstream end to a downstream end, wherein the at least one flow path is configured to receive flow only in the axial direction.

12. The pump element of claim 11, wherein the piston assembly includes
a piston rod having a driven end and defining a first sealing diameter, and
a piston head coupled to the piston rod and defining a second dealing diameter greater than the first sealing diameter, the at least one flow path being defined by the piston head.

13. The pump element of claim 12, wherein each of the piston rod and the piston head has a continuous, solid peripheral wall free from apertures.

14. The pump element of claim 13, wherein at least a portion of the peripheral wall of the piston head is in sealing relationship with the chamber to define a high pressure area of the chamber.

15. The pump element of claim 12, wherein the at least one flow path includes a plurality of flow paths, each having a corresponding inlet at a first axial end of the piston head.

16. The pump element of claim 15, wherein the plurality of flow paths converge to a single outlet at a second axial end of the piston head.

17. The pump element of claim 12, further comprising a biasing member biasing the piston assembly to the first position, the piston head including a seat receiving a portion of the biasing member.

18. The pump element of claim 12, further comprising an inlet valve supported by the piston head, the piston head including
a seat surface selectively contacting a valve element of the inlet valve, and
a plurality of retainers configured to retain the inlet valve element with respect to the axial flow element.

19. The pump element of claim 18, wherein the inlet valve element is a disk.

20. The pump element of claim 12, wherein the piston head is entirely constructed of a non-metallic material.
